(19) United States
(12) Patent Application Publication
(10) Pub. No.: US 2007/0079799 A1
(43) Pub. Date: Apr. 12, 2007

(54) Efficient dispersion device

(76) Inventor: Douglas G. Scouten, San Clemente, CA (US)

Correspondence Address: HOWARD J. GREENWALD P.C., 349 W. COMMERCIAL STREET SUITE 3075, EAST ROCHESTER, NY, 14445-2408, US

(21) Appl. No.: 11/405,114

(22) Filed: Apr. 17, 2006

Related U.S. Application Data
(63) Continuation-in-part of application No. 11/129,964, filed on May 16, 2005, now Pat. No. 7,044,114.

(51) Int. Cl. F02B 31/04

(52) U.S. Cl. 123/306

(57) ABSTRACT

A fuel conditioning device for increasing fuel burning efficiency and reducing pollutant emissions. The device contains: a hollow housing with an interior wall with a first surface roughness, a flow diverter disposed in an intermediate portion of such hollow housing, and a compound venturi disposed in said hollow housing downstream of such flow diverter. The compound venturi contains a multiplicity of radial venturis and a descending conical section disposed downstream from said radial venturis. The descending conical section is defined by a wall whose interior surface has a second surface roughness that is no greater than 0.1 times as great as said first surface roughness.

### CROSS-REFERENCE TO RELATED PATENT APPLICATION

This patent application is a continuation-in-part of applicant's copending patent application Ser. No. 11/129,964, filed on May 16, 2005.

### FIELD OF THE INVENTION

A fluid conditioning device comprised of a hollow housing, at least one flow diverter, and a compound venturi.

### BACKGROUND OF THE INVENTION

Prior art internal combustion engines burned at relatively low efficiencies and thereby produced exhausts comprised of numerous pollutants; these pollutants included, e.g., unburned hydrocarbons, low valence nitrogen oxides (such as NOₓ), carbon monoxide, and the like. Such inefficiencies also resulted in wasted fuel.

The need to more efficiently utilize hydrocarbon fuels has become painfully evident within the last few years. Efforts have been made to provide internal combustion engines that operate at higher temperatures and that use computer control of fuel air mixes. Automobiles have been provided with after-burning devices (such as, e.g., catalytic converters) in order to reduce pollutants; such after-burning devices increase the inefficiencies of the internal combustion systems of which they are comprised.

Applicant has designed, and patented, devices that agitate fuel just prior to entry into the cylinder of an internal combustion engine for combustion. Such devices, are described, e.g., in U.S. Pat. Nos. 5,069,191 and 5,148,794, the entire disclosure of each of which is hereby incorporated by reference into this specification. These devices have shown promise in increasing fuel burning efficiency, but suffer from several disadvantages. One drawback is that they are complicated and expensive to manufacture. For example, as shown in U.S. Pat. No. 5,069,191, a complicated grooved insert within a chamber and a complex flanged member requiring alternate ridges and grooves are required. The device described in U.S. Pat. No. 5,148,794 is even more complex. Both of these devices also use a complex, multipart machined housing structure. Despite their complexities, these devices still do not provided the desired improvement in fuel efficiency and in the reduction of exhaust pollutants.

It is an object of this invention to provide an improved fuel conditioning device for increasing fuel burning efficiency and for reducing pollutant emissions.

### SUMMARY OF THE INVENTION

In accordance with the invention, there is therefore provided a fluid conditioning device for increasing fuel burning efficiency and reducing pollutant emissions that is comprised of a hollow housing, at least one flow diverter, and a compound venturi. The hollow housing preferably includes: a first end for receiving a combustible liquid fuel supply and supplying it to an intermediate portion of said housing; an intermediate portion comprising an eddy chamber for receiving fuel from the first end and creating turbulence and mixing within the fuel, said eddy chamber being designed for receiving at least one flow diverter for diverting at least a portion of the flow from the first end in a direction at an angle of from about 30 to about 90 degrees to an original direction of flow from the first end; and a second end for receiving a compound venturi for accepting fuel from the intermediate portion. The flow diverter is disposed in the eddy chamber, and it is adapted to divert at least a portion of the flow from the first end in a direction at an angle of from about 30 to about 90 degrees to an original direction of flow from the first end. The compound venturi is disposed in the second end of the housing for accepting fuel from the intermediate portion, and it comprises a central venturi for accepting a majority of the fuel provided by the intermediate portion and radial venturis for receiving a portion of the fuel from the intermediate portion and directing it in a direction at an angle of from about 30 to about 90 degrees to a longitudinal axis of the central venturi to create turbulence in fuel passing through the central venturi; such compound venturi is provided with an outlet end for connection to a conduit for passing fuel from the central venturi to a fuel combustion chamber.

In another embodiment, the aforementioned fluid conditioning device is disposed in a fuel supply prior to an engine fuel intake.

### BRIEF DESCRIPTION OF THE DRAWINGS

The invention will be described by reference to this specification and to the enclosed drawings, in which like numerals refer to like elements, and wherein:

FIG. 1 is an exploded perspective view of one preferred embodiment of the invention, showing an exploded view of a compound venturi;

FIG. 1A is an enlarged view of the compound venturi used in the device depicted in FIG. 1;

FIG. 2 is a longitudinal, cross-sectional view of the device of FIG. 1 with crossed flow diverters and without the compound venturi being assembled;

FIG. 2a is a downstream end view of the device of FIG. 2;

FIG. 2B is a perspective view of one preferred diverter 14a;

FIG. 3 is a longitudinal cross sectional view of another preferred device of the invention;

FIG. 4 is a perspective view of a flow diverter for use in the device of FIGS. 2, 2a and 3;

FIG. 5 is a cross sectional view of a preferred device using a flow diverter in planar rather than crossed configuration;

FIG. 6 is a cross sectional view of a housing used in the assembly of the invention; and

FIG. 7 is a schematic illustration of a heated fluid conditioning device.

### DESCRIPTION OF THE PREFERRED EMBODIMENTS

In one embodiment, the fluid conditioning device of this invention operates through the use of a fuel redirecting apparatus, such as a flow diverter, that redirects a secondary portion of supply fuel flowing through the device to cause it to collide with a primary portion of supply fuel flowing though the device and to create initial turbulent flow; this feature operates in combination with a complex venturi that redirects a portion of the initial turbulent flow through at least one secondary venturi to form secondary venturi flow that impinges the balance of the initial turbulent flow either just before or while the balance of the initial turbulent flow passes through a primary venturi. In one aspect of this embodiment, the redirecting apparatus redirects the secondary supply fuel portion so that it collides with the primary supply fuel portion at an angle of from about 30 to about 90 degrees and most preferably from about 60 to about 90 degrees. Similarly, the secondary venturi preferably directs the secondary venturi flow so that it collides with the balance of the initial turbulent flow at an angle of from about 30 to about 90 degrees, and most preferably at an angle of from about 60 to about 90 degrees. Generally a plurality (e.g., 2 to 4) secondary venturis are provided.

The hollow housing, in its simplest form, is a tubular member having first and second ends for connection to a fuel supply line at its first end and for receiving a complex venturi at its second end. For ease in connection, the ends are preferably provided with internal (female) threads.

The flow diverter may be any device that redirects a portion of the flow; it may be any structure that accepts flow and reroutes it so that it leaves in a different direction than a direction in which it entered. Such structures may, for example, be blind boxes or tubes having one open end and one closed end where the flow enters the open end in one direction and exits through one or more side walls in a different direction. Other such structures may be one or more tubular flow directors where flow enters one open end of a bent tubular structure in one direction and is redirected by walls of the tube so that flow exits in a different direction. The terms “tube” or “tubular,” as used in this context, refer to a hollow elongated cylinder or prism. In a preferred embodiment the flow diverter is a hollow block having an open end and a closed end and having a plurality of side walls with openings having central axes that are at from about 30 to about 90 degrees with respect to a line passing from a center of the open end to a center of the closed end. When the flow diverter is inserted into the housing, it is preferably oriented so that the open end faces a first end of the housing such that a portion of fuel entering the eddy chamber (between the housing ends) enters the open end and exits through the flow diverter openings at an angle to fuel flowing around the flow diverters within the eddy chamber.

In one preferred embodiment, the flow diverter includes a pair of mating pieces, each of which has a sidewall and at least one of which has sidewall openings, the pieces together being provided with, two edge walls and an end wall such that when the pieces are combined, the edge walls and end wall are connected by both sidewalls to form a hollow chamber having an open end with openings in at least one of the sidewalls. Usually, a plurality of flow diverters are provided, each of which has a rectangularly shaped open end with a longitudinal axis and the flow diverters are arranged in series such that the longitudinal axes of the open ends are in intersecting planes.

The compound venturi for insertion into the second end of the housing accepts fuel from the intermediate portion and is a combination of a central venturi for accepting a majority of the fuel provided by the intermediate portion and radial venturis for receiving a portion of the fuel from the intermediate portion and directing it in a direction at an angle of from about 30 to about 90 degrees to a longitudinal axis of the central venturi, thereby creating turbulence in fuel passing through the central venturi. The radial venturis may direct flow to the fuel passing through the central venturi either just prior to entry into the central venturi or during passage through the central venturi. The term “venturi,” as used herein, means a restriction in a fluid conductor causing a pressure drop and an increase in velocity. The compound venturi is preferably provided with an outlet end for connection to a conduit for passing fuel from the central venturi to a fuel combustion chamber.

In one preferred embodiment, the fluid flow device of this invention produces fluid flow with a Reynolds number of greater than 2,000. As is known to those skilled in the art, Reynolds number is a dimensionless number that is equal to the density of a fluid times its velocity times a characteristic length divided by the fluid viscosity, and it is also known as the Damkohler number. Reference may be had, e.g., to U.S. Pat. No. 3,952,577 (apparatus for measuring the flow rate and/or viscous characteristics of fluids), U.S. Pat. No. 5,105,843 (isocentric low turbulence injector), U.S. Pat. No. 5,647,201 (cavitating venturi for low reynolds number flows), U.S. Pat. No. 5,835,884 (method of determining a characteristic of a fluid), U.S. Pat. No. 7,000,463 (reynolds number correction function for mass flow rate sensor), and the like. The entire disclosure of each of these United States patents is hereby incorporated by reference into this specification.

In one embodiment, the Reynolds number of the fluid flow produced by the device of invention is greater than 3,000. In another embodiment, the Reynolds number of the fluid flow produced by the device of invention is greater than 3,500. In yet another embodiment, the Reynolds number of the fluid flow produced by the device of invention is greater than 3,900.

Reference will now be had to the drawings for a more specific description of a preferred embodiment of the invention.

### The Embodiments Described in the Drawings

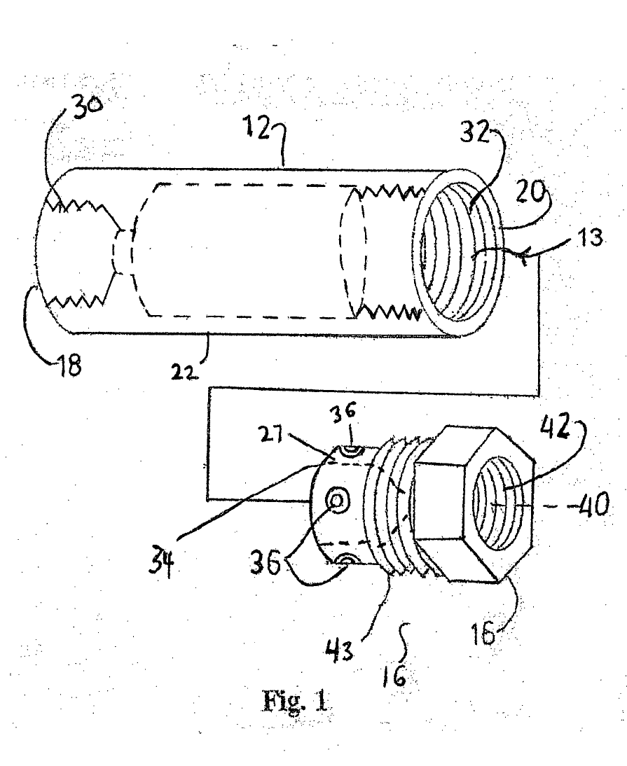

FIG. 1 is an exploded perspective view of a fluid flow device 10 that is comprised of a housing 12 and a compound venturi 16.

Referring to FIG. 1 et seq., and to the preferred device 10 depicted therein, such device 10 of the invention is provided with a housing 12, a pair of flow diverters 14a and 14b inserted into the housing 12 at right angles to each other, and a compound venturi 16.

In the embodiment depicted, housing 12 has a substantially circular cross-sectional shape. As will be apparent to those skilled in the art, other shapes may be used for housing 12 (such as, e.g., a square shape), provided that the cross-sectional shape of the interior 13 of housing 12 be substantially circular.

The housing 12 includes a first end 18 and a second end 20. The first end 18 preferably receives a combustible liquid fuel supply and supplies it to an intermediate portion 22 of housing 12. Such intermediate portion is shown in dotted line outline.

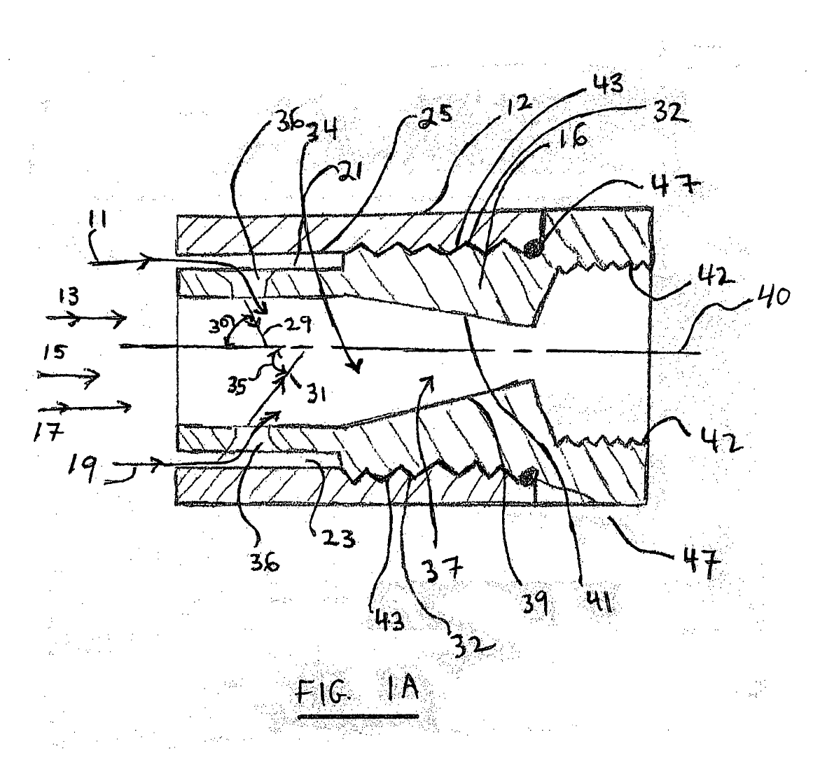

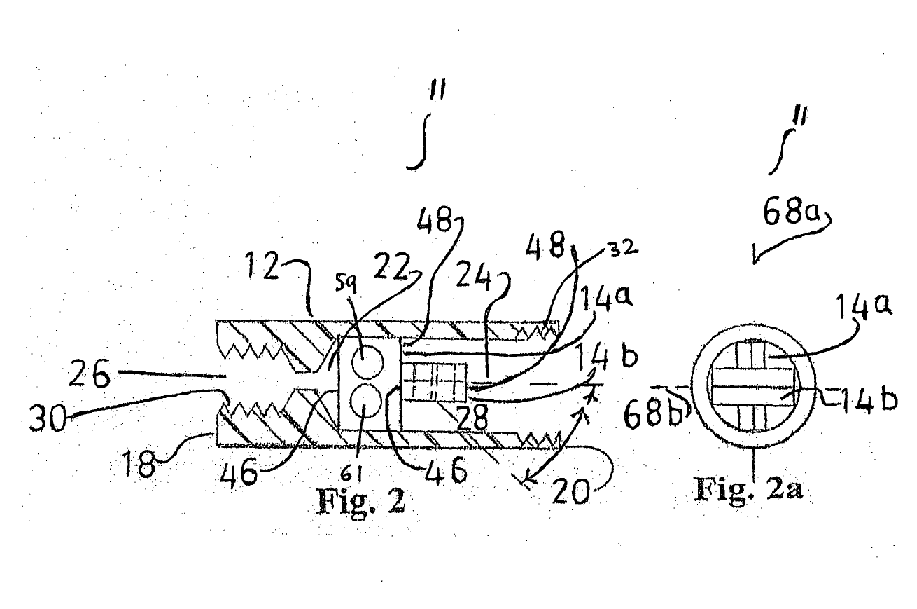

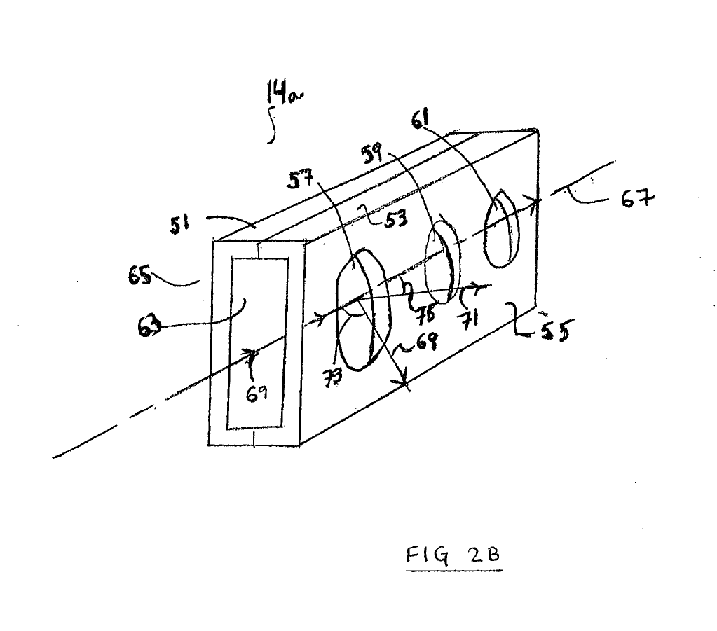

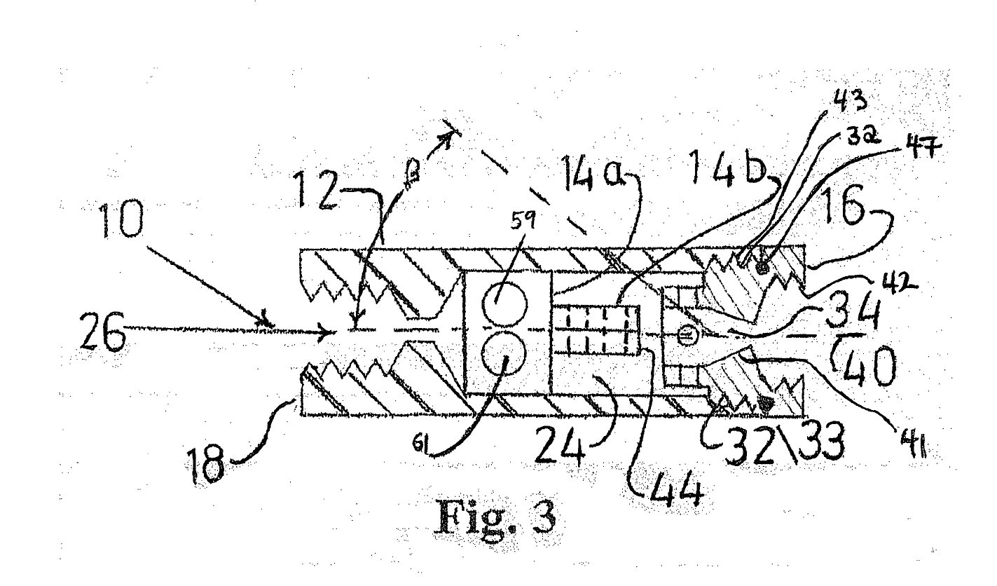

The intermediate portion 22 preferably comprises eddy chamber (not shown in FIG. 1, but see FIG. 2 et seq.) for receiving fuel from the first end 18 and creating turbulence and mixing within the fuel.

The second end of housing 12 is adapted to receive a compound venturi 16; the compound venturi receives fuel from intermediate portion 22. The second end 20 is designed to receive the compound venturi 16 for accepting fuel from the intermediate portion 22. The first end 18 of the housing 12 preferably has a female thread 30 for mating with a female thread (not shown) on a fuel supply line (not shown) and the second end 20 of the housing 12 preferably has a female thread 32 for mating with a male thread 33 on the compound venturi 16.

In the preferred embodiment depicted in FIG. 1, the compound venturi 16 includes a central venturi 34 for accepting a majority of the fuel provided by the intermediate portion 22 and radial venturis 36 for receiving a portion of the fuel from the intermediate portion 22 and directing it in a direction of from about 30 to about 90 degrees to a longitudinal axis 40 of the central venturi 34 to create turbulence in fuel passing through the central venturi 34. Compound venturi 16 being provided with an outlet end 42 for connection to a conduit for passing fuel from the central venturi to a fuel combustion chamber.

FIG. 1A is an enlarged view of compound venturi 16 illustrating the preferred direction of fluid flow through said venturi. Referring to FIG. 1A, fluid from intermediate portion 22 (not shown in FIG. 1A, but see FIG. 1) flows in the directions of arrows 11, 13, 15, 17, and 19. The compound venturi 16 is disposed within the housing 12, and there are spaces 21 and 23 between the inner wall 25 of housing 12 and the outer wall 27 of venturi 16. The fluid flowing in the direction of arrows 11 and 19 flows into such spaces 21 and 23 and through radial venturis 36 (shown in greater detail in FIG. 1).

Referring to FIG. 1, and to the preferred embodiment depicted therein, it is preferred that there be at least 4 radial venturis extending through the outer wall 27 of venturi 16. In one embodiment, there are at least about 8 such radial venturis.

Referring again to FIG. 1A, for the sake of simplicity of representation, only two such radial venturis 36 are shown. The fluid passing through the radial venturis 36 is directed in the direction of arrows 29 and 31 in an direction at an angle of from about 50 to about 90 degrees (and preferably from about 30 to about 90 degrees) to the original direction of flow of fluid flows 11 and 19. Inasmuch as fluid flows 11 and 19 are generally parallel to the centerline 40 of compound venturi 16, the flows 29 and 31 form angles 33 and 35 with centerline 40 that also are preferably from about 30 to about 90 degrees.

Referring again to FIG. 1A, and in the preferred embodiment depicted therein, it will be seen that compound venturi 16 is comprised of a descending conical section defined by interior walls 39 and 41; although two walls 39 and 41 are referred to, it should be apparent that they are different sections of the same continuous wall. In one preferred aspect of this embodiment, interior walls 39 and 41 are substantially smooth, having an average surface roughness of less than about 10 nanometers and, preferably, having an average surface roughness of less than about 0.1 times the surface roughness of the interior wall of the housing 12. As is known to those skilled in the art, average surface roughness is often measured by an atomic force microscope (AFM). Reference may be had, e.g., to U.S. Pat. No. 5,420,796 (method of inspecting planarity of wafer surface), U.S. Pat. Nos. 6,610,004, 6,140,014, 6,548,139, 6,383,404, 6,586,322, 5,832,834, and 6,342,277. The entire disclosure of each of these United States patents is hereby incorporated by reference into this specification.

Alternatively, or additionally, one may measure surface roughness by a laser interference technique. This technique is well known. Reference may be had, e.g., to U.S. Pat. No. 6,285,456 (dimension measurement using both coherent and white light interferometers), U.S. Pat. Nos. 6,136,410, 5,843,232 (measuring deposit thickness), U.S. Pat. No. 4,151,654 (device for measuring axially symmetric aspherics), and the like. The entire disclosure of these United States patents are hereby incorporated by reference into this specification.

Alternatively, or additionally, the surface roughness of walls 39 and 41 may be measured by the well known rms surface roughness test. Reference may be had, e.g., to U.S. Pat. No. 6,004,189 (finishing of tungsten carbide surfaces), U.S. Pat. No. 6,066,028 (polishing of copper), U.S. Pat. No. 6,171,224 (finishing of tungsten carbide surfaces), U.S. Pat. No. 6,951,695 (high surface quality GaN wafer), and the like. The entire disclosure of each of such United States patents is hereby incorporated by reference into this specification.

Regardless of how the surface roughness of walls 39 and 41 are measured, they are substantially smoother than the inner wall of housing 12. Referring to FIG. 1, it will be seen that housing 12 is comprised of an inner wall that is comprised of a multiplicity of roughened surfaces. Thus, e.g., as will be seen in FIG. 1, housing 12 is comprised of female threads 13.

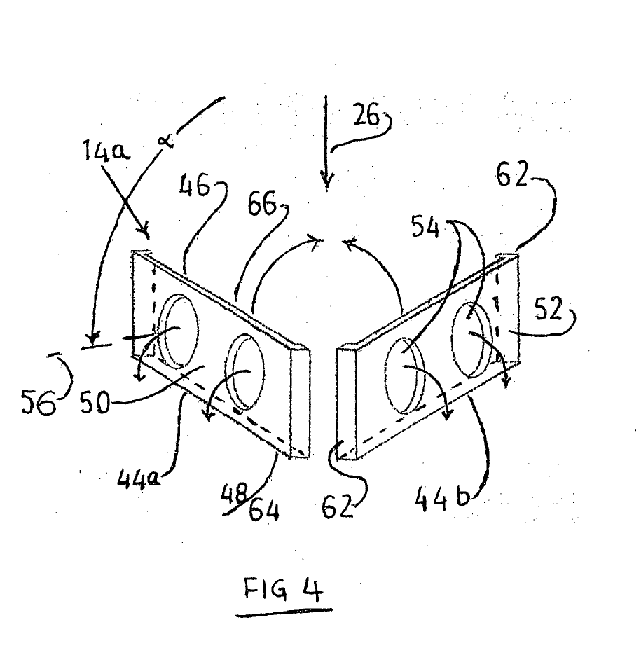

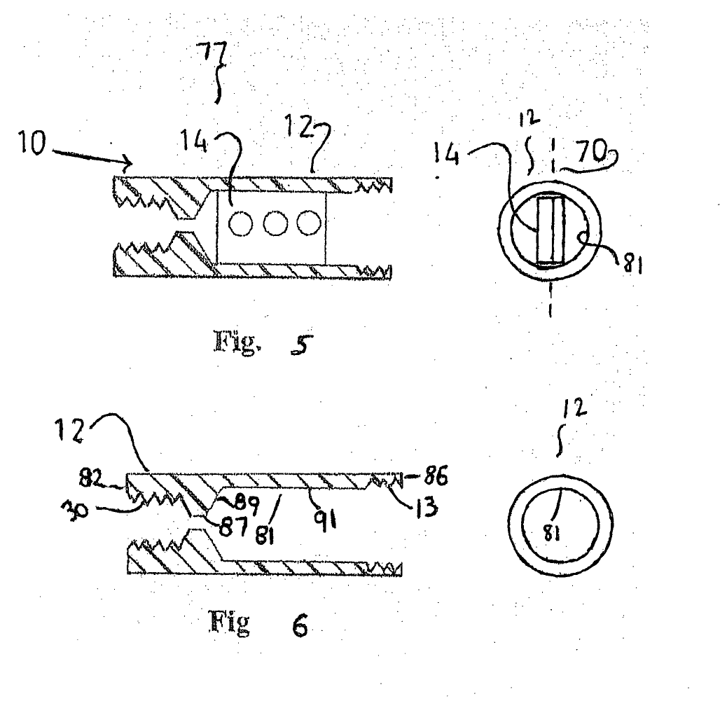

FIGS. 5 and 6 better illustrate the configuration of a preferred inner wall 81 of housing 12. As will be apparent to those skilled in the art, the surface roughness of inner wall 81 will vary from point 83 to point 85. However, each of the threaded areas 13 and 30, and the non-threaded areas 87, 89, and 91 will have a surface roughness that is substantially greater than the surface roughness of the walls 39 and 41. In one embodiment, the rms surface roughness of each of the areas 13, 30, 87, 89, and 91 is at least 10 times as great as the rms surface roughness of the walls 39 and 41 and, more preferably, at least about 50 times as great. In another embodiment, the average rms surface roughness of the areas 13, 30, 87, 89, and 91 is at least 10 times as great as the surface roughness of the walls 30 and 41 and, more preferably, at least about 50 times as great.

In one aspect of this embodiment, each of the walls 87, 89, and 91 is etched to increase its surface roughness such that each of such walls has an irregular roughness of from about 0.001 micron to about 1000 microns. Such roughness may be created, e.g., by means of parallel grooves created by laser etching, by means of threads, etc. Means for obtaining roughness by etching are known in the art. For example, reference may be had to U.S. Pat. No. 6,861,364 to Koide (Laser etching method and apparatus therefore) the content of which are hereby incorporated by reference into this specification.

Referring again to FIG. 1, an in the embodiment depicted therein, it will be seen that compound venturi 16 is comprised of male threads that are adapted to engage with female threads 32 of housing 12 (also

Referring again to FIG. 1A, and in the preferred embodiment depicted therein, an O-ring 47 helps insure a fluid tight connection between the housing 12 and the compound venturi 16. In one aspect of this embodiment, such O-ring is comprised of “Viton,” a fluoroelastomer based on the copolymer of vinylidene fluoride and hexafluoropropylene that is sold by the E.I. Du Pont de Nemours Company of Wilmington, Del.

In order to insure the best sealing, it is preferred to utilize a thread sealing material between threads 32 and 43. These materials are well known to those skilled in the art. Reference may be had, e.g., to U.S. Pat. No. 4,872,914 (high purity, high temperature pipe thread sealant paste), U.S. Pat. No. 5,093,015 (thread sealant an anti-seize compound), and the like. The entire disclosure of each of these United States patents is hereby incorporated by reference into this specification.

Referring again to FIG. 1, the intermediate section 22 is preferably adapted to receive at least one flow diverter that is best illustrated in FIG. 2.

Referring to FIG. 2, and to the preferred embodiment depicted therein, it will be seen that device 11 is comprised of two flow diverters, flow diverter 14a, and flow diverter 14b. Each such flow diverter is preferably adapted to divert at least one portion of the fluid flow from the first end of housing 12 in a direction at an angle of from about 5 to about 90 degrees (and preferably from about 30 to about 90 degrees) to an original direction of flow from such first end.

In one preferred embodiment, best illustrated in FIG. 2B, each flow diverter 14a and 14B is preferably comprised of mating pieces 51 and 53, each of which has a sidewall (such as sidewall 55), and at least one of which has sidewall openings (such as openings 57, 59, and 61). The diverters 14a and 14b are comprised of a hollow chamber having an open end 65 and a closed end 67. In the embodiment depicted in FIG. 2B, the open end 65 is substantially rectangularly shaped, and it is substantially symmetrically disposed about a longitudinal axis 67.

Referring again to FIG. 2B, and in one preferred embodiment, at least a portion of the fluid flow into diverter 14A is in the direction of arrow 69, and such fluid flow is either coincident with longitudinal axis 67 or substantially parallel therewith. The diverter causes the fluid flow in the direction of arrow 69 to flow out of openings 57, 59, and 61. At least a portion of the fluid flowing out of openings 57, 59, and/or 61 flows in a direction that is from about 5 to about 90 degrees (and preferably about 30 to about 90 degrees) to the original direction of flow 69 (and also, in this case, to longitudinal axis 67). In the embodiment depicted in FIG. 2B, the fluid flow from openings 59 and 61 is in the direction of arrows 69 and 71, at angles 73 and 75, respectively, to longitudinal axis 67. As will be apparent, each of angles 73 and 75 is from about 30 to about 90 degrees.

Referring again to FIG. 2, one or more of the diverters 14a/14b is disposed in the intermediate chamber 22 upstream from the compound venturi 16. The intermediate chamber is designed for receiving at least one flow diverter (14a, 14b) for diverting the direction 26 of at least a portion of the flow from the first end 18 to a direction 28 at an angle α of from about 30 to about 90 degrees to original direction 26 of flow from the first end 18. The second end 20 is designed to receive the compound venturi 16 for accepting fuel from the intermediate portion 22. The first end 18 of the housing 12 preferably has a female thread 30 for mating with a male thread on a fuel supply line and the second end 20 of the housing 12 preferably has a female thread 32 for mating with a male thread 33 on the compound venturi 16.

In one embodiment (see FIG. 1A), the device includes a central venturi 34 for accepting a majority of the fuel provided by the intermediate portion 22 and radial venturis 36 for receiving a portion of the fuel from the intermediate portion 22 and directing it in a direction at an angle β of from about 30 to about 90 degrees to a longitudinal axis 40 of the central venturi 34 to create turbulence in fuel passing through the central venturi 34, said compound venturi 16 being provided with an outlet end 42 for connection to a conduit for passing fuel from the central venturi to a fuel combustion chamber.

In one preferred embodiment shown, as best seen in FIG. 6, the flow diverters include a pair of mating pieces 44a, 44b, each of which has a sidewall 50, 52 and at least one of which has sidewall openings 54, the pieces together being provided with, two edge walls 62 and an end wall 64 such that when the pieces 44a, 44b are combined, the edge walls 62 and end wall 64 are connected by both sidewalls 50, 52 to form a hollow chamber 66 having an open end 46 with openings 54 in at least one of the sidewalls 50, 52.

In one embodiment shown in the FIGS. 2 and 2A, the device is provided with a plurality of flow diverters 14a, 14b. One embodiment of these flow diverters 14a/14b is illustrated in FIG. 4. Referring to FIG. 4, each of the flow diverters 14a/14b has a rectangularly shaped open end 46 with a longitudinal axis 58 and the flow diverters 14a, 14b are arranged in series such that the longitudinal axes 58 of the open ends 46 are in intersecting planes 68a, 68b.

The embodiment shown in FIG. 5 is a device 77 that utilizes one or more flow diverters 14 arranged in a single plane 70.

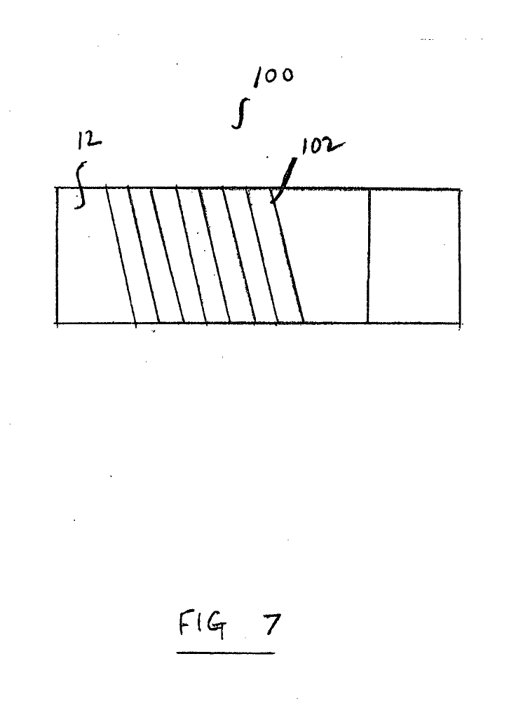

FIG. 7 is a schematic illustration of a heated fluid flow device 10 that is substantially identical to the device 10 depicted in FIG. 1 et seq. but differs therefrom in having a means 102 for heating such device 10 to a temperature of from about 60 to about 120 degrees Fahrenheit and, more preferably, from about 75 to about 110 degrees Fahrenheit. One may use any conventional means for heating such device 10. Thus, e.g., one may contact 10 with hot radiator fluid, and/or hot intake gas, and/or hot exhaust gas.

In the embodiment depicted in FIG. 7, a heating coil 102 is used to heat the device 10. One may use any of the heating coils known to those skilled in the art for this purpose.

By way of illustration, and not limitation, U.S. Pat. No. 3,907,946 describes an electrical heating coil for heating the fuel system of an internal combustion engine. In column 2 of this patent, it is disclosed that: “Operation of the system is enabled by four-position switch 40, movable contact T1 of which is connected to one set of contacts 42 of ignition switch 44 of a vehicle, which is in turn connected to the positive side of a vehicle battery. One lead 46 of solenoid valve 30 is connected to the cathode of isolation diode 48 and contact T2 of switch 40. One lead 50 of solenoid valve 34 is connected to contact T5 of switch 40 and to the anode of isolation diode 52. The opposite leads of solenoid valves 30 and 34 are tied to common ground 54. Evaporation chamber 12 is heated from one or both of two sources. Solid nichrome element 56, through which fuel is injected into evaporation chamber 12, is adapted to heat or vaporize the inflowing fuel in approximately three to four seconds. One end 57 of heating element 58 is grounded (connected to the negative terminal of the vehicle battery) through the housing of vaporization chamber 12 and ground terminal 60. The outer end of element 58 is selectively tied to +V battery supply through switch contacts 62. This heating element may be omitted if instant starting (in less than three seconds) of the vapor system is not necessary. The second and sustaining heating element 58 of vaporization chamber 12 is connected between ground terminal 60 and contacts T4 of four-position switch 40. This heating element is also energized through isolation diodes 52 and 66, the anodes of which are tied to contacts T3 and T5 of four-position switch 40. The temperature of vaporization chamber 12 is indicated by temperature gauge 68, one terminal of which is grounded and the other terminal of which is connected through temperature sensor 70 of vaporization chamber 12 to +V battery potential.”

By way of further illustration, one may use one or more of the heating assemblies disclosed in U.S. Pat. No. 4,274,390 (automotive hot water heater), U.S. Pat. No. 5,477,035 (high frequency induction and method with temperature control), U.S. Pat. No. 5,667,710 (electrical heater device), and the like. The entire disclosure of each of these United States patents is hereby incorporated by reference into this specification.

The process described and claimed in U.S. Pat. No. 5,477,035 is of interest and may be used to heat the device 12. Such patent claims, in claim 1 thereof, “1. A high frequency induction method with temperature control using a high frequency induction coil and a high frequency power source directly connected to said coil via a condenser for supplying an alternating current with high frequency, comprising the steps of: (a) starting high frequency induction for heating a workpiece by supplying high frequency electricity, from said high frequency power source, to a series resonance circuit including said high frequency induction coil for heating said workpiece by high frequency induction heating, and said condenser; (b) unifying the phases of a high frequency voltage and current output respectively from said high frequency power source, thereby maintaining said resonance circuit in a resonance state at a resonance frequency corresponding to the temperature of said workpiece; and (c) controlling the temperature of said workpiece on the basis of a resonance frequency, said resonance frequency varying with the increase in the temperature of said workpiece in said resonance state.

The fluid flow conditioning device of this invention has many applications including, by way of illustration and not limitation, use in implantable medical devices, use in diesel engines, gasoline engines, alcohol engines, propane engines, biodiesel engines, natural gas engines, and the like.

Many different embodiments of the invention may be made without departing from the spirit and scope thereof, and they are intended to be included within the invention.

I claim:

1. A fuel conditioning device for increasing fuel burning efficiency and reducing pollutant emissions comprising:
(a) a hollow housing, said housing including:
i) a first end for receiving a combustible liquid fuel supply and supplying it to an intermediate portion of said housing;
ii) an intermediate portion comprising an eddy chamber for receiving fuel from the first end and creating turbulence and mixing within the fuel, said eddy chamber being designed for receiving at least one flow diverter for diverting at least a portion of the flow from the first end in a direction at an angle of from about 30 to about 90 degrees to an original direction of flow from the first end; and
iii) a second end for receiving a compound venturi for accepting fuel from the intermediate portion;
iv) a interior wall with a first rms surface roughness;
(b) at least one flow diverter inserted into the eddy chamber for diverting at least a portion of the flow from the first end in a direction at an angle of from about 30 to about 90 degrees to an original direction of flow from the first end; and
(c) a compound venturi inserted into the second end of the housing for accepting fuel from the intermediate portion, said compound venturi comprising a central venturi for accepting a majority of the fuel provided by the intermediate portion and radial venturis for receiving a portion of the fuel from the intermediate portion and directing it in a direction at an angle of from about 30 to about 90 degrees to a longitudinal axis of the central venturi to create turbulence in fuel passing through the central venturi, said compound venturi being provided with an outlet end for connection to a conduit for passing fuel from the central venturi to a fuel combustion chamber, and said compound venturi; and
(d) said compound venturi is comprised of a descending conical section disposed downstream from said radial venturis, wherein said descending conical section is defined by a wall whose interior surface has a second rms surface roughness that is no greater than 0.1 times as great as said first rms surface roughness.

2. The fuel conditioning device as recited in claim 1, wherein said second rms surface roughness is no greater than about 0.02 times as great as said first rms surface roughness.

3. The fuel conditioning device as recited in claim 1, wherein said second end of said housing has a female thread for mating with a male thread on said compound venturi.

4. The fuel conditioning device as recited in claim 1, wherein said flow diverter comprises a hollow block having an open end and a closed end and having a plurality of side walls with openings having central axes that are at from about 30 to about 90 degrees with respect to a line passing from a center of the open end to a center of the closed end.

5. The fuel conditioning device as recited in claim 1, wherein said flow diverter comprises a pair of mating pieces, each of which has a sidewall and at least one of which has sidewall openings, the pieces together being provided with two edge walls and an end wall such that when the pieces are combined, the edge walls and end wall are connected by both sidewalls to form a hollow chamber having an open end with openings in at least one of the sidewalls.

6. The fuel conditioning device as recited in claim 1, wherein said device is comprised of a plurality of flow diverters, each of which has a rectangularly shaped open end with a longitudinal axis, and said flow diverters are arranged in series such that the longitudinal axes of the open ends are in intersecting planes.

7. The fuel conditioning device as recited in claim 1, wherein said compound venturi is comprised of at least 4 radial venturis.

8. The fuel conditioning device as recited in claim 1, wherein said compound venturi is comprised of at least 8 radial venturis.

9. The fuel conditioning device as recited in claim 1, wherein said wall of said descending conical section has an average surface roughness of less than about 10 nanometers.

10. The fuel conditioning device as recited in claim 1, wherein said device is comprised of an 0-ring disposed between said housing and said compound venturi.

11. The fuel conditioning device as recited in claim 10, wherein said O-ring is comprised of a fluoroelastomer.

12. The fuel conditioning device as recited in claim 10, wherein said device is comprised of thread sealing material disposed between said housing and said compound venturi.

13. A fuel conditioning device for increasing fuel burning efficiency and reducing pollutant emissions comprising:
(a) a hollow housing, said housing including:
i) a first end for receiving a combustible liquid fuel supply and supplying it to an intermediate portion of said housing;
ii) an intermediate portion comprising an eddy chamber for receiving fuel from the first end and creating turbulence and mixing within the fuel, said eddy chamber being designed for receiving at least one flow diverter for diverting at least a portion of the flow from the first end in a direction at an angle of from about 30 to about 90 degrees to an original direction of flow from the first end; and
iii) a second end for receiving a compound venturi for accepting fuel from the intermediate portion;
(b) means for heating said hollow housing to a temperature of from about 60 to about 120 degrees Fahrenheit;
(c) at least one flow diverter inserted into the eddy chamber for diverting at least a portion of the flow from the first end in a direction at an angle of from about 30 to about 90 degrees to an original direction of flow from the first end; and
(d) a compound venturi inserted into the second end of the housing for accepting fuel from the intermediate portion, said compound venturi comprising a central venturi for accepting a majority of the fuel provided by the intermediate portion and radial venturis for receiving a portion of the fuel from the intermediate portion and directing it in a direction at an angle of from about 30 to about 90 degrees to a longitudinal axis of the central venturi to create turbulence in fuel passing through the central venturi, said compound venturi being provided with an outlet end for connection to a conduit for passing fuel from the central venturi to a fuel combustion chamber, and said compound venturi.

14. The fuel conditioning device as recited in claim 13, wherein said compound venturi is comprised of a descending conical section disposed downstream from said radial venturis, and wherein said descending conical section is defined by a wall whose interior surface has a second rms surface roughness that is no greater than 0.1 times as great as said first rms surface roughness.

15. The fuel conditioning device as recited in claim 14, wherein said device is comprised of means for heating said hollow housing to a temperature of from about 75 to about 110 degrees Fahrenheit.

16. The fuel conditioning device as recited in claim 13, wherein said means for heating said hollow housing is comprised of a heating coil.

17. The fuel conditioning device as recited in claim 16, wherein said heating coil is an electrical heating coil.

18. The fuel conditioning device as recited in claim 13, wherein said means for heating said hollow housing is comprised of a high frequency induction coil.
